(19) United States
(12) Patent Application Publication
(10) Pub. No.: US 2018/0222770 A1
(43) Pub. Date: Aug. 9, 2018

(54) LEAF AND DEBRIS FILTER FOR SWIMMING POOL

(71) Applicant: Dan Poirier, Austin, TX (US)

(72) Inventor: Dan Poirier, Austin, TX (US)

(21) Appl. No.: 15/862,797

(22) Filed: Jan. 5, 2018

Related U.S. Application Data
(60) Provisional application No. 62/442,666, filed on Jan. 5, 2017.

(51) Int. Cl. C02F 1/00; E04H 4/12; B01D 29/13; B01D 39/14

(52) U.S. Cl. CPC C02F 1/004; E04H 4/1272; C02F 2103/42; B01D 39/14; B01D 29/13

(57) ABSTRACT

A device for inhibiting debris from flowing into a pool skimmer includes: a filtering material which has a shape and size configured to substantially cover an opening to a channel leading to the pool skimmer; a collection material coupled to the filtering material, wherein the collection material is positioned below the filtering material such that debris, inhibited from flowing into the channel by the filtering material, is deposited onto the collection material; and a mounting system for coupling the filtering material to the channel.

### PRIORITY CLAIM

This application claims priority to U.S. Provisional Application Ser. No. 62/442,666 entitled “LEAF AND DEBRIS FILTER FOR SWIMMING POOL” filed Jan. 5, 2017, which is incorporated herein by reference in its entirety.

### BACKGROUND OF THE INVENTION

### 1. Field of the Invention

The invention generally relates to aquatic debris filters. More particularly, the invention relates to debris filters for swimming pools.

### 2. Description of the Relevant Art

Most residential and public swimming pools have a skimmer compartment with a skimmer basket that slides into the skimmer compartment to filter out debris such as leaves, insects, etc. to keep them from getting into the pool filtering system. Typically, there is an opening in the side of a swimming pool that forms a channel into the skimmer to allow water to flow from the pool into the skimmer compartment. An flap (or some other backflow device) is usually placed inside the channel to helps prevent debris from flowing back into the pool from the skimmer compartment. The skimmer compartment is a vertical circular cavity with piping at the bottom which connects to a water pump and continues on through a filter and then back into the pool through a separate opening. In the skimmer compartment is a skimmer basket that filters out the debris mentioned above from the water before it flows into a water pump and the swimming pool filter. This basket can be slid in and out of the skimmer compartment so the debris can be removed from an access port above.

If the swimming pool is in an area where there are trees that fall into the pool (especially during fall and winter seasons), the skimmer basket may fill up with debris, restricting or even stopping the flow of water through the system. The restricted water flow puts strain on the water pump which shortens the life of the pump or may even burn it out. There is, therefore, a need to prevent excessive debris from clogging up the skimmer.

### SUMMARY OF THE INVENTION

A device for inhibiting debris from flowing into a pool skimmer includes: a filtering material which has a shape and size configured to substantially cover an opening to a channel leading to the pool skimmer; a collection material coupled to the filtering material, wherein the collection material is positioned below the filtering material such that debris, inhibited from flowing into the channel by the filtering material, is deposited onto the collection material; and a mounting system for coupling the filtering material to the channel.

In one embodiment, the device includes a handle coupled to the mounting system.

In one embodiment, the filtering material is formed from a mesh polymeric material.

In one embodiment, the mounting system comprises a mounting member that is positionable in the channel leading to the pool skimmer. The mounting member may include a pair of flexible mounting members which apply force to walls of the channel to secure the device to the channel.

In one embodiment, the mounting system comprises a cable connected to an anchor that is positionable in the pool skimmer.

In one embodiment, the mounting system comprises one or more suction cups which couple the device to a wall proximate to the channel leading to the pool skimmer.

In one embodiment, the device includes a support coupled to the filtering material and/or the collection material, wherein the filtering material and/or the collection material is formed from a substantially flexible material and wherein the support provides shape to the filtering material and/or the collection material.

In one embodiment, the collection material is cup shaped.

### BRIEF DESCRIPTION OF THE DRAWINGS

Advantages of the present invention will become apparent to those skilled in the art with the benefit of the following detailed description of embodiments and upon reference to the accompanying drawings in which:

FIG. 1 depicts a first embodiment of a debris filter for a swimming pool;

FIGS. 2A-C depict an alternate embodiment of a debris filter;

FIGS. 3A-C depict an alternative embodiment of a debris filter;

FIGS. 4A-4C depict an alternative embodiment of a debris filter;

FIG. 5 depicts the use of vertically oriented elastic members in the device of FIG. 1;

FIG. 6 depicts the use of vertically oriented elastic member in the device of FIG. 4;

FIGS. 7A and 7B depict an alternate embodiment of a mounting system;

FIG. 8 depicts a cable attached to a weight that is used to couple the debris filter to the channel;

FIGS. 9A-9F depict various embodiments of anchoring devices;

FIG. 10 depicts a compressible material formed on the contact surface of a debris filter;

FIGS. 11A-11D depict alternate embodiments of mounting systems used to secure the debris filter to the channel;

FIG. 12 depicts an alternate embodiment of a debris filter mounting system;

FIG. 13 depicts an alternate embodiment of a debris filter;

FIG. 14 depicts a typical above-ground pool skimmer; and

FIG. 15 depicts an alternate embodiment of a leaf/debris guard.

While the invention may be susceptible to various modifications and alternative forms, specific embodiments thereof are shown by way of example in the drawings and will herein be described in detail. The drawings may not be to scale. It should be understood, however, that the drawings and detailed description thereto are not intended to limit the invention to the particular form disclosed, but to the contrary, the intention is to cover all modifications, equivalents, and alternatives falling within the spirit and scope of the present invention as defined by the appended claims.

### DETAILED DESCRIPTION OF THE PREFERRED EMBODIMENTS

It is to be understood the present invention is not limited to particular devices or methods, which may, of course, vary. It is also to be understood that the terminology used herein is for the purpose of describing particular embodiments only, and is not intended to be limiting. As used in this specification and the appended claims, the singular forms “a”, “an”, and “the” include singular and plural referents unless the content clearly dictates otherwise. Furthermore, the word “may” is used throughout this application in a permissive sense (i.e., having the potential to, being able to), not in a mandatory sense (i.e., must). The term “include,” and derivations thereof, mean “including, but not limited to.” The term “coupled” means directly or indirectly connected.

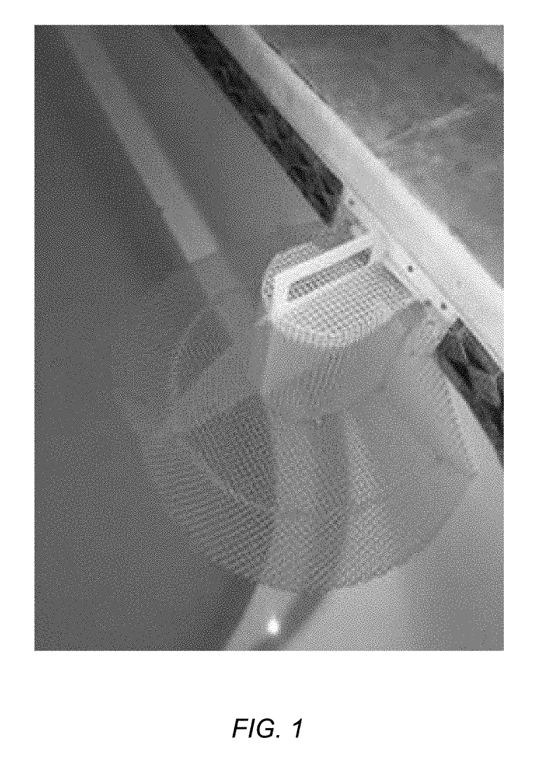

FIG. 1 depicts a first embodiment of a debris filter for a swimming pool. As used herein, the term “swimming pool” refers to in-ground pools (e.g., residential and municipal in-ground pools) and above-ground pools. A swimming pool may be made from concrete, fiberglass or vinyl materials, The debris filter includes a filtering material that has a shape and size configured to substantially cover the opening of a channel leading to a pool skimmer. The filtering material may be composed of a polymeric or metal material. The filtering material may have a mesh configuration. The mesh size may be varied for the intended use, however, typical mesh sizes used are sufficient to inhibit the passage of leaves through the mesh while allowing sufficient flow of water through the filtering material. In a specific embodiment, the filtering material may be formed from a variety of materials including but not limited to polyvinyl chloride (PVC), chlorinated polyvinyl; chloride (CPVC), acrylonitrile butadiene styrene (ABS), ultra-high molecular weight polyethylene, (UHMWPE), aluminum, stainless steel, and other materials that are substantially inert in swimming pool water.

The debris filter also includes a collection material coupled to the filtering material. The collection material is positioned below the filtering material such that debris, inhibited from flowing into the channel is deposited onto the collection material. The collection material may be formed from the same material as the filtering material or from a different material. The collection material may be a solid material or a mesh material. Preferably the collection material is formed from a mesh material to allow water to drain from the collection material when the debris filter is removed from the pool. When using a mesh collection material, the mesh size of the collection material may be the same or different from the mesh size of the filtering material.

The debris filter of FIG. 1 includes a mounting member which couples the filtering material and the collection material to the channel. Preferably the mounting member will allow quick connection/disconnection of the debris filter onto the opening of the channel. In the embodiment of FIG. 1 a mounting member includes a one or more polymeric members which are inserted into the channel to secure the debris filter to the opening of the channel. Other mounting systems may be used. For example, one or more suction cups may be coupled to the filtering material, or the collection material, to hold the debris filter against the wall in front of the opening. Other mounting systems may be used, as will be described further.

The debris filter may include one or more supports coupled to the filtering material and/or the collection material. When a flexible material is used for the filtering material and/or the collection material, the one or more supports may provide a surface for the materials to be attached. The supports are configured to provide a shape to the flexible filtering material and/or the flexible collection material. The debris filter of FIG. 1 may also include a handle to allow easy setup and removal of the filter. The handle may be mounted to any portion of the debris filter. In some embodiment, the handle is mounted to various supports coupled to the filtering material and/or the collection material.

During use the debris filter is mounted to the skimmer channel such that the filtering material is positioned over the opening of the channel. The skimmer will create a flow of water toward the opening of the channel. This flow of water will carry debris (e.g., leaves) toward the filtering material. The filtering material will act to prevent at least some of the debris from entering the channel. For example, debris that is larger than the mesh size of the filtering material will be prevented from entering the channel. The filtered debris will sink to the collection material, where the filtered debris is collected. Periodically (e.g., daily, weekly, etc.) the collected debris is removed from the debris filter. In an embodiment, a person removes the debris filter from the channel, using the handle, and the debris filter, along with the collected debris, is removed from the pool. The collected debris is dumped or washed from the collection material, away from the pool, and the debris filter returned to its position in front of the channel opening.

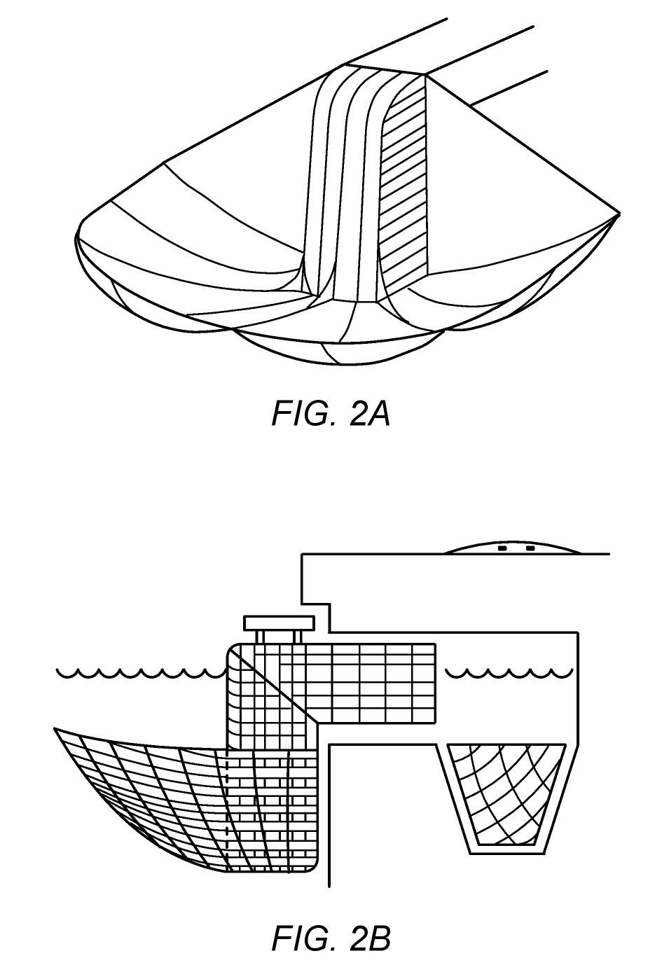

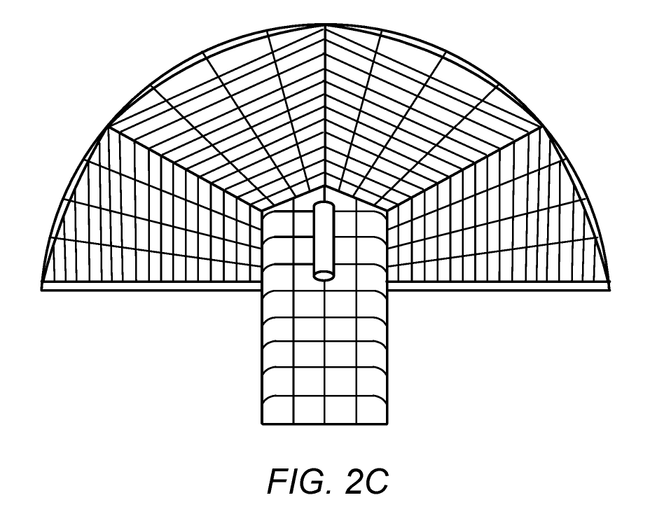

FIGS. 2A-C depicts an alternate embodiment of a debris filter. The embodiment of FIGS. 2A-C include many of the same features as the embodiment of FIG. 1. FIG. 2A depicts a projection view of the debris filter. From this view, the collection material can be seen to have a cupped shape. The cupped shape of the collection material may help to prevent the collected debris from falling off the collection material when the debris filter is removed from the pool. FIG. 2B depicts a side view of the debris filter when inserted into the channel. In this embodiment, the mounting system is formed from a rigid mesh material that creates a friction fit within the channel. The mounting system, alternatively, may be formed from a rigid mesh material that does not contact the walls of the channel, but has a tolerance within the channel that is sufficient to prevent the debris filter from being pushed away from the wall. FIG. 2C depicts a top view of the debris filter. The handle can be seem connected to a portion of the filtering material.

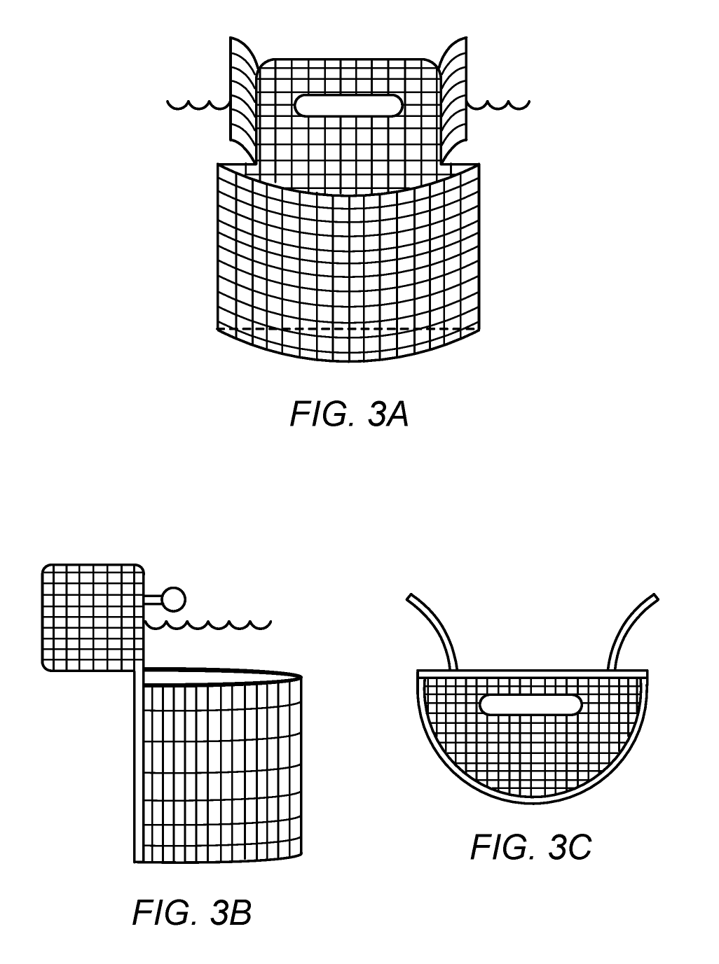

FIGS. 3A-C depict an alternative embodiment of a debris filter. FIG. 3A depicts a front view of the debris filter. FIG. 3B depicts a side view of the debris filter. FIG. 3C depicts a top view of the debris filter. The debris filter has a rounded shape (compared to the square/rectangular shape of the debris filters of FIGS. 1 and 2). The debris filter includes a filtering material that is a planar sheet of a mesh material. The debris filter also includes a collection material coupled to the filtering material. The collection material is positioned below the filtering material such that debris, inhibited from flowing into the channel is deposited onto the collection material. The collection material is formed into a rounded cup which catches the debris stopped by the filtering material. The debris filter of FIG. 3 includes a mounting system which couples the filtering material and the collection material to the channel. As seen in FIGS. 3A and 3C, the mounting system is formed from two elastic members that extend from the back side of the planar filtering material. During use the elastic members are compressed and pushed into the channel of the skimmer. Once compression of the elastic members is released, the elastic members are allowed to expand into the channel, forming a compression fit between the mounting system and the channel. The elastic members may be formed from a mesh material so that the flow of water through the channel is not significantly inhibited. A handle, as shown in FIGS. 3A-C, is coupled to the filtering material and allows easy access to the debris filter.

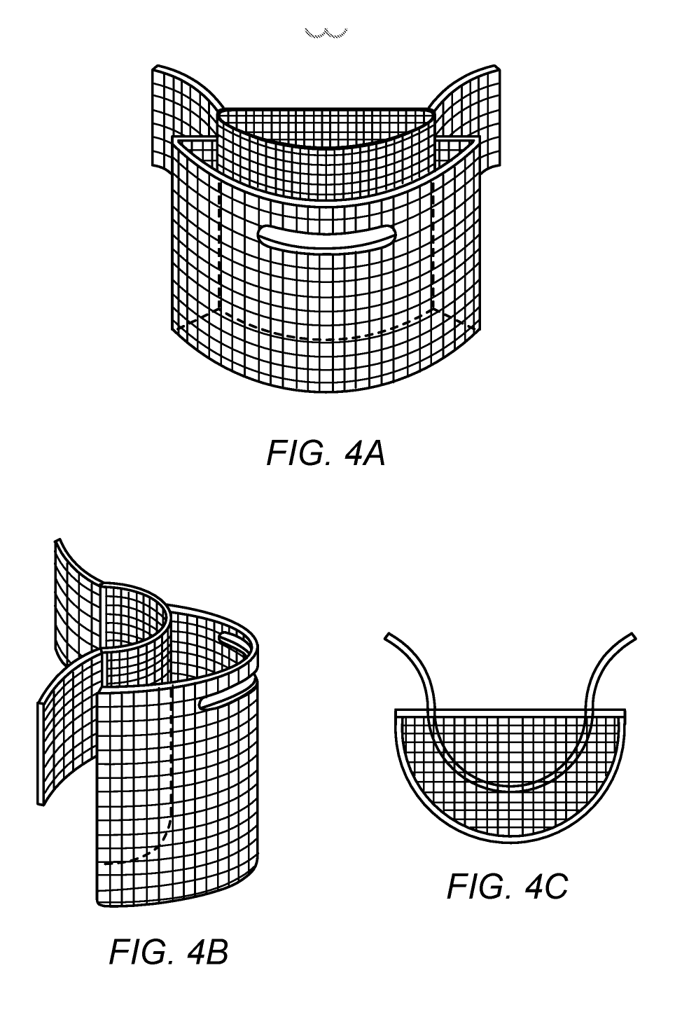

FIGS. 4A-4C depict an alternative embodiment of a debris filter. FIG. 4A depicts a front view of the debris filter. FIG. 4B depicts a side view of the debris filter. FIG. 4C depicts a top view of the debris filter. The debris filter is similar to the debris filter depicted in FIG. 3, but differs in that the filtering member also has a rounded shape (compared to the planar shape of the filtering member in FIG. 3). The debris filter includes a filtering material that is a rounded sheet of a mesh material. The debris filter also includes a collection material coupled to the filtering material. The collection material is formed into a rounded cup surrounding the rounded filtering member. The debris filter of FIG. 4 includes a mounting system which is similar to the mounting system of FIG. 3. A handle, as shown in FIGS. 4A-C, is formed in the collection material and allows easy access to the debris filter.

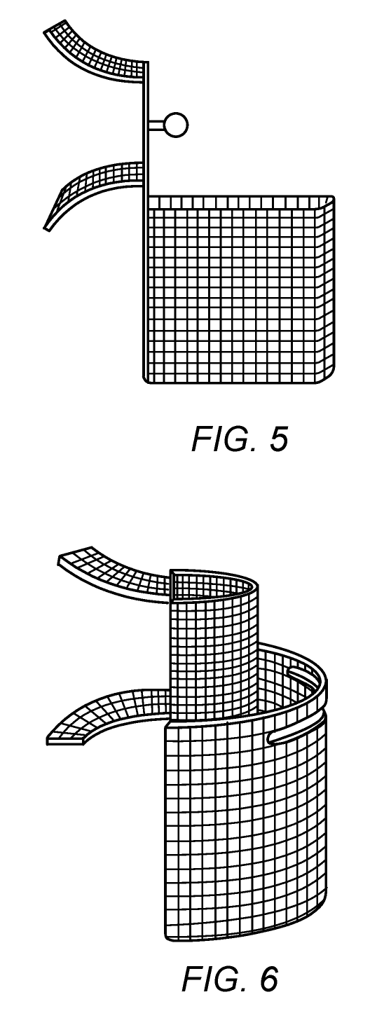

In FIGS. 3 and 4, a mounting system is depicted which includes two elastic members that extend from the back side of the planar filtering material. In the embodiments depicted in FIGS. 3 and 4, the elastic members are formed in such a way that the elastic members will contact the sidewalls of the channels to secure the debris filter to the channel (referred to herein as a “horizontal orientation”). In an alternate embodiment, depicted in FIGS. 5 and 6, the elastic members may be oriented such that the elastic members contact the top and bottom walls of the channel (referred to herein as a “vertical orientation”). FIG. 5 depicts the use of vertically oriented elastic members in the device of FIG. 1. FIG. 6 depicts the use of vertically oriented elastic member in the device of FIG. 4.

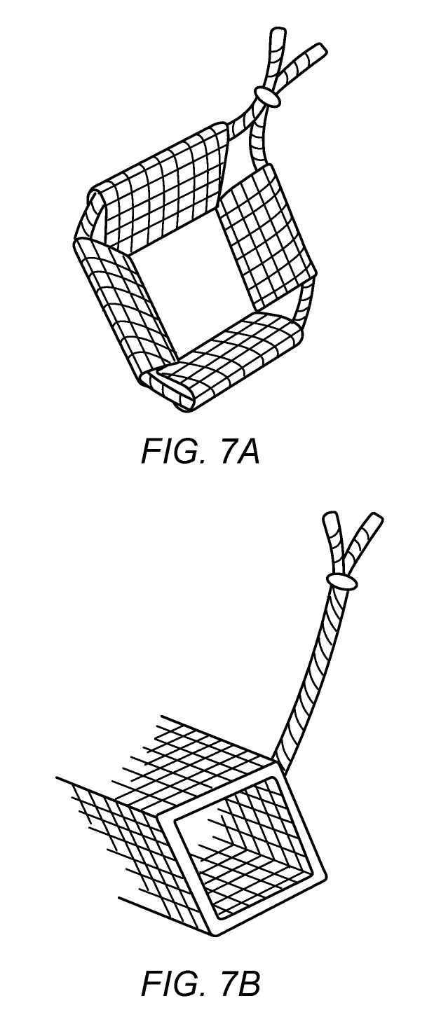

FIGS. 7A and 7B depict an alternate embodiment of a mounting system. FIG. 7B depicts an embodiment of a mounting system that includes 4 elastic members which are in a contracted state. A cable, or some other suitable device, can be tensioned to hold the elastic members in a compressed state. The mounting system can then be inserted into the channel, and the tension on the cable released. Upon release of the tension, the mounting system expands, as depicted in FIG. 7A and makes contact with the sidewalls, the top wall, and the bottom wall, to retain the debris filter in the channel.

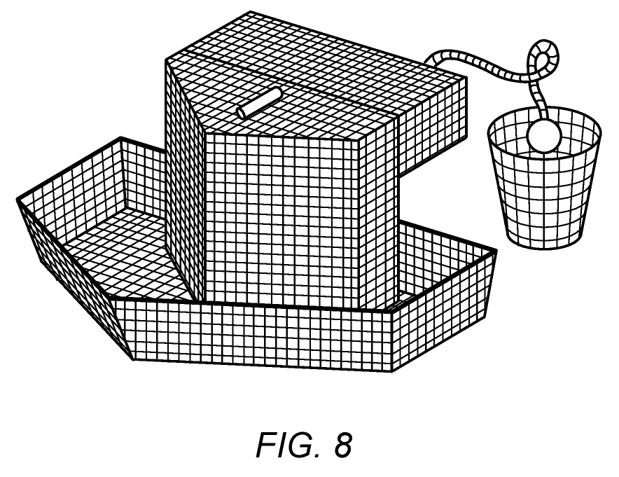

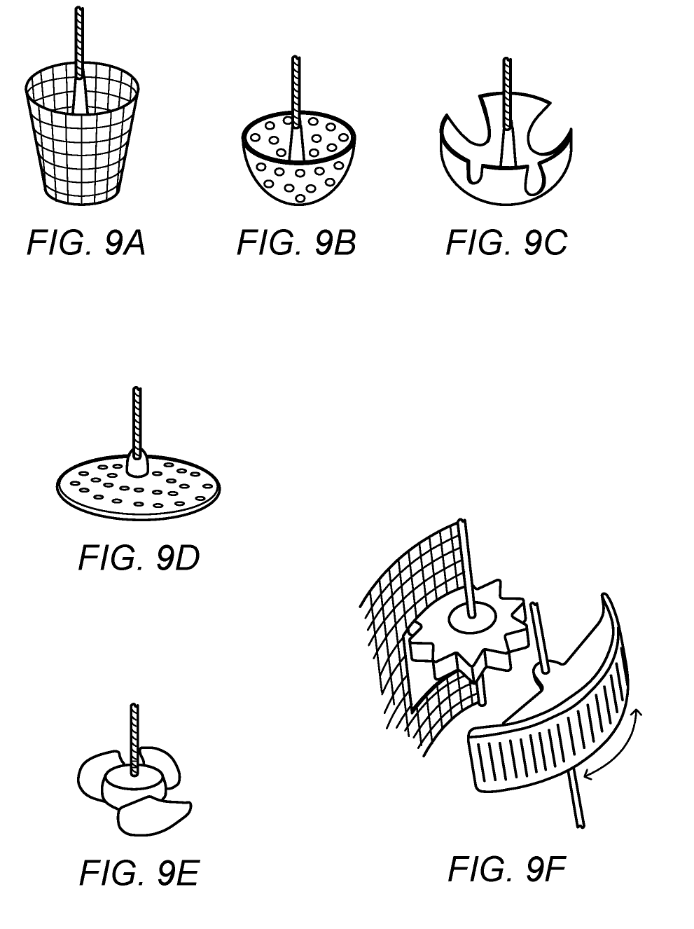

Other mounting systems may be used to couple the debris filter to the skimmer channel. In an embodiment, depicted in FIG. 8, a cable attached to a weight is used to couple the debris filter to the channel. In an embodiment, the cable runs through the channel and into the skimmer basket, as depicted in FIG. 8. A variety of different anchoring devices may be used in the mounting system depicted in FIG. 8. FIGS. 9A-9E depict various embodiments. Alternatively, the anchoring device of the mounting system may be a ratcheting system which allows the debris filter to be pulled against the wall using a ratchet, as depicted in FIG. 9F.

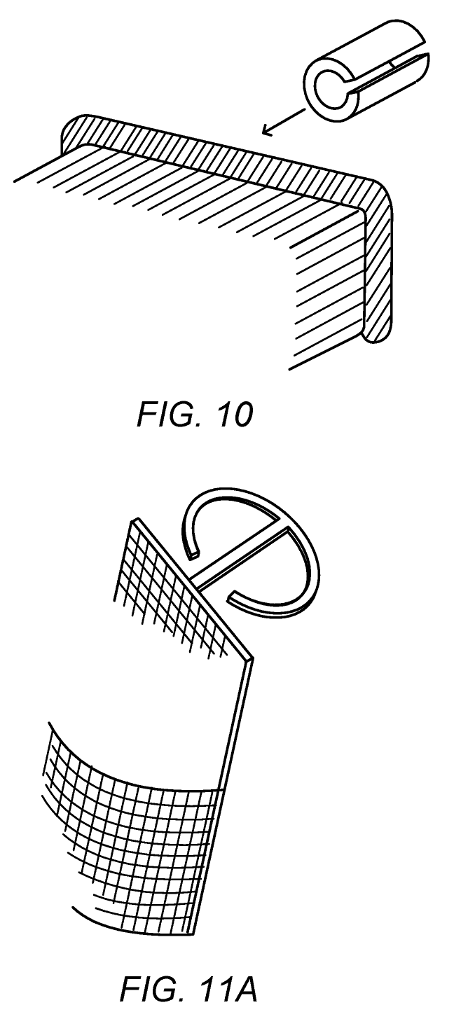

As depicted in FIG. 10, a compressible material may be formed around the edge of the filtering member that is in contact with the pool wall. The compressible material may be used to form a tight fit against the wall when the debris filter is installed in front of the opening. The compressible material may help prevent debris from passing around the filtering material, especially for pools that have rounded walls.

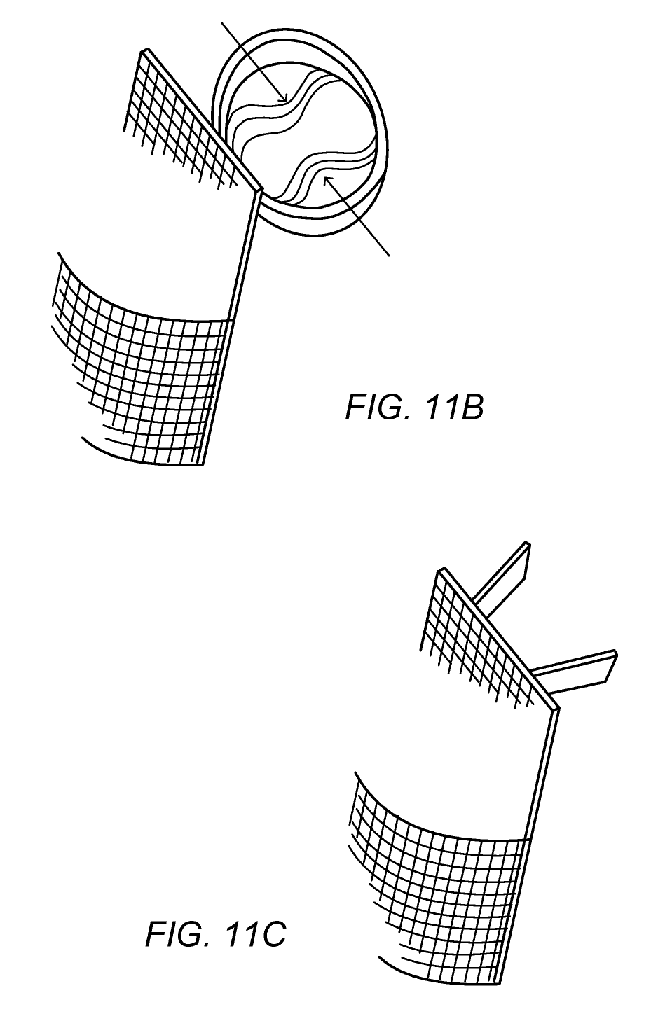

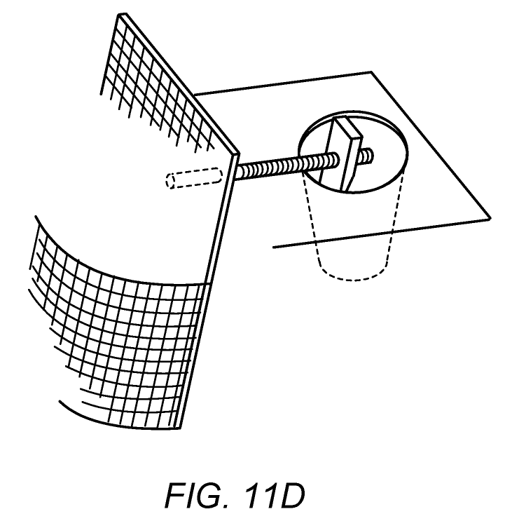

FIGS. 11A-11D depict alternate embodiments of mounting systems used to secure the debris filter to the channel. FIGS. 11A-11C represent alternatives to the flexible elastic members depicted in FIGS. 3-6. FIG. 11D depicts a bolted anchoring system that attaches the debris filter using a bolt that extends from the debris filter, through the channel and into the skimmer basket. Any of these mounting systems can be used with any of the debris filters described herein.

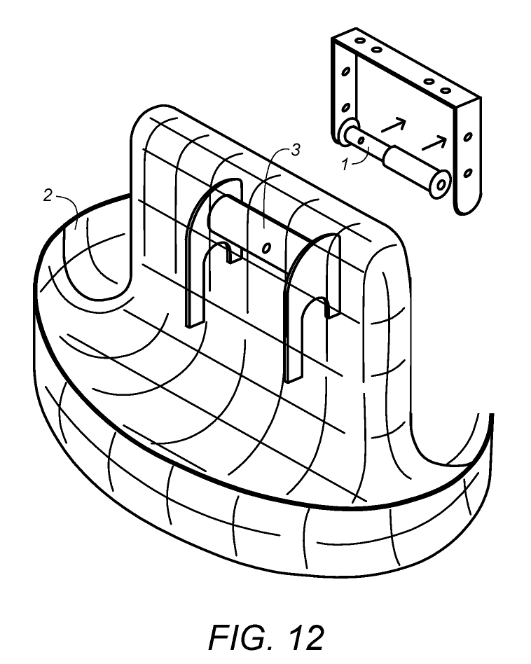

FIG. 12 depicts an alternate embodiment of a debris filter mounting system. The mounting system includes an expandable bar (1) which can be inserted into the channel of the skimmer. During use, the bar is compressed and placed inside the channel. Upon release of the compression force, the bar expands and is held in the channel by the expansion force. In an embodiment, the compression/expansion of the bar is achieved by a spring within the expandable bar. The basket (2) includes a handle/mount (3). The handle/mount (3) includes a handle portion that allows a user to move the basket in front of, and away from, the skimmer channel. A mounting bracket is also incorporated into the handle/mount. The mounting bracket can be secured to the expandable bar to hold the basket in place in front of the skimmer channel.

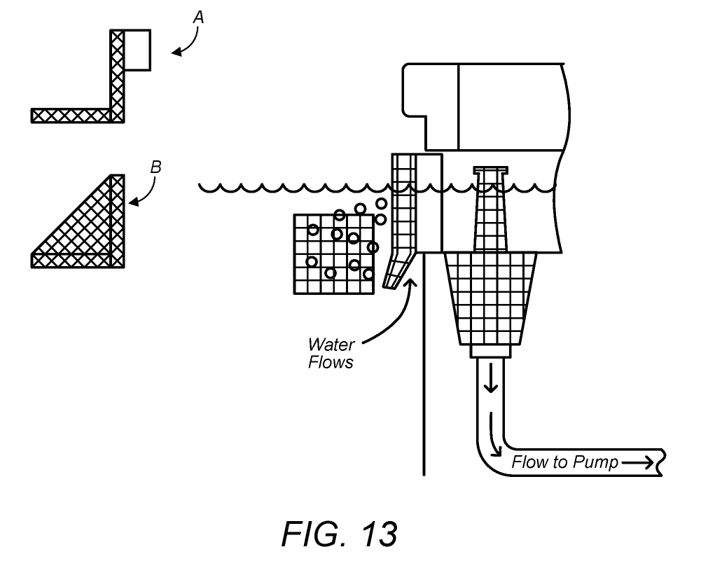

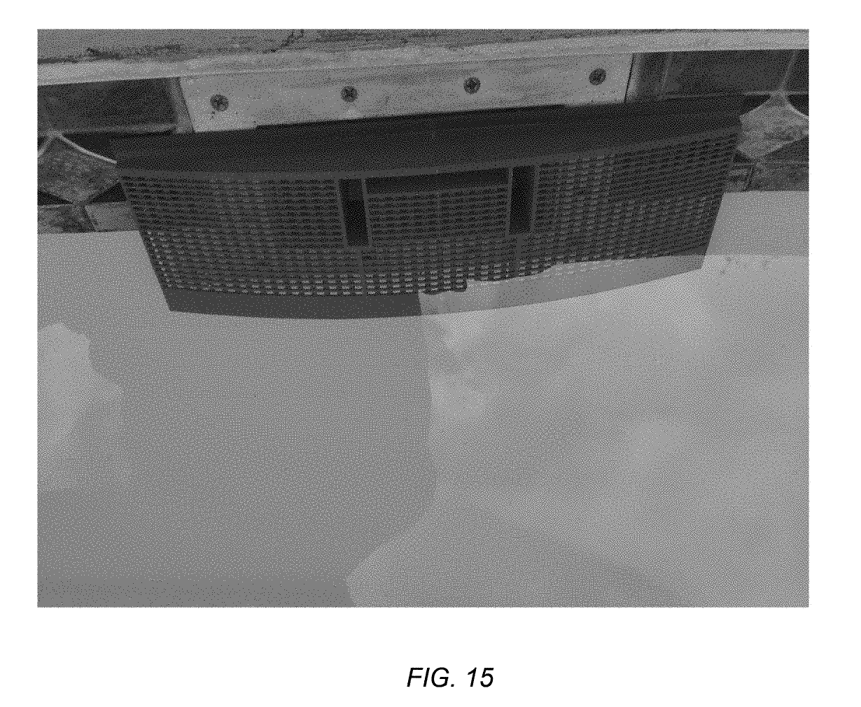

FIG. 13 depicts an alternate embodiment of a debris filter. The debris filter includes a leaf/debris guard (A) and a shelf (B) to catch and remove leaf and debris. Use of a two part construction offers a number of advantages. The leaf/debris guard (A) is removable and adjustable to fit various openings. Shelf (B) can be removable (two-part construction) or may be incorporated together in a one-piece construction. An alternate embodiment of a leaf/debris guard is depicted in FIG. 15.

The leaf and debris guard of any of the embodiments described herein may be coupled to the skimmer Suctions cups, clamping force, magnets, hook and loop fasteners, or a separate connection basket may be used to mount any of the leaf and debris device embodiments described herein.

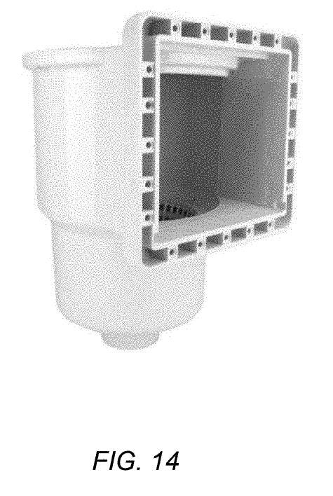

While the embodiments described herein are shown in relation to an in-ground pool skimmer, it should be understood that the debris filters can also be applied to skimmers for above-ground and in-ground vinyl and fiberglass pools. A typical above-ground pool skimmer is depicted in FIG. 14. As depicted in FIG. 14, the above-ground skimmer includes a flanged mount that is used to fasten the skimmer through the side of the pool. A support structure, for holding a debris filter in front of the skimmer inlet, may be mounted to the face (e.g., the flanged mount) of the skimmer using existing fasteners. A removable portion of the debris filter is located on the fixed support structure and lifted off to dispose of debris.

The examples disclosed herein are included to demonstrate preferred embodiments of the invention. It should be appreciated by those of skill in the art that the techniques disclosed in the examples which follow represent techniques discovered by the inventor to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

What is claimed is:

1. A device for inhibiting debris from flowing into a pool skimmer comprising:
a filtering material which has a shape and size configured to substantially cover an opening to a channel leading to the pool skimmer;
a collection material coupled to the filtering material, wherein the collection material is positioned below the filtering material such that debris, inhibited from flowing into the channel by the filtering material, is deposited onto the collection material; and
a mounting system for coupling the filtering material to the channel.

2. The device of claim 1, further comprising a handle coupled to the mounting system.

3. The device of claim 1, wherein the filtering material is formed from a mesh polymeric material.

4. The device of claim 1, wherein the mounting system comprises a mounting member that is positionable in the channel leading to the pool skimmer.

5. The device of claim 4, wherein the mounting system comprises a pair of flexible mounting members which apply force to walls of the channel to secure the device to the channel.

6. The device of claim 1, wherein the mounting system comprises a cable connected to an anchor that is positionable in the pool skimmer.

7. The device of claim 1, wherein the mounting system comprises one or more suction cups which couple the device to a wall proximate to the channel leading to the pool skimmer.

8. The device of claim 1, further comprising a support coupled to the filtering material and/or the collection material, wherein the filtering material and/or the collection material is formed from a substantially flexible material and wherein the support provides shape to the filtering material and/or the collection material.

9. The device of claim 1, wherein the collection material is cup shaped.

10. A method of filtering debris from a pool, comprising:
obtaining a device for filtering leaves and debris, the device comprising:
a filtering material which has a shape and size configured to substantially cover an opening to a channel leading to the pool skimmer;
a collection material coupled to the filtering material, wherein the collection material is positioned below the filtering material such that debris, inhibited from flowing into the channel by the filtering material, is deposited onto the collection material; and
a mounting system for coupling the filtering material to the channel; and
placing the device in the intake of a pool skimmer.
